(19) United States
(12) Patent Application Publication
(10) Pub. No.: US 2007/0016420 A1
(43) Pub. Date: Jan. 18, 2007

(54) Dictionary lookup for mobile devices using spelling recognition

(75) Inventors: Ophir Azulai, Haifa (IL); Ron Hoory, Haifa (IL); Zohar Sivan, Zichron Ya'akov (IL)

Correspondence Address: Stephen C. Kaufman;IBM CORPORATION, Intellectual Property Law Dept., P. O. Box 218, Yorktown Heights, NY, 10598, US

(73) Assignee: International Business Machines Corporation, Armonk, NY (US)

(21) Appl. No.: 11/176,154

(22) Filed: Jul. 7, 2005

(51) Int. Cl. G10L 15/04; G10L 15/00

(52) U.S. Cl. 704/254

(57) ABSTRACT

A method for querying an electronic dictionary using letters of an alphabet enunciated by a user includes accepting a speech input from the user. The speech input includes a sequence of spelled letters enunciated by the user that spell a query word. The speech input is analyzed to determine one or more sequences of the letters that approximate the sequence of spelled letters. The one or more sequences of the letters are post-processed so as to produce a plurality of recognized words approximating the query word. The electronic dictionary is queried with the plurality of recognized words so as to retrieve a respective plurality of dictionary entries. A list of results including the plurality of recognized words and the respective plurality of dictionary entries is presented to the user.

### FIELD OF THE INVENTION

The present invention relates generally to speech recognition systems, and particularly to methods and systems for querying an electronic dictionary using spoken input.

### BACKGROUND OF THE INVENTION

Many mobile devices and desktop applications enable users to query electronic dictionaries. A dictionary may comprise, for example, a thesaurus or lexicon that provides definitions of words or phrases. In, other applications, bilingual or multilingual dictionaries provide translation of words from one language to another.

A number of data entry methods are known in the art for entering a word or phrase to be looked-up in the dictionary. In some applications, the user types the query word using a keyboard or keypad. For example, Ectaco, Inc. (Long Island City, N.Y.) offers a number of handheld electronic dictionaries and translators. One exemplary product is described in www.ectaco.com/dictionaries/view_info.php3?refid=831&pagelang=23&dict_id=92. Other applications use speech recognition methods, in which the user vocally pronounces the query word. For example, Ectaco, Inc., offers a multilingual translator called “UT-103 Universal Translator” that supports voice input. Additional details regarding this product can be found at www.universal-translator.net.

Some dictionary applications use Optical Character Recognition (OCR) methods for entering queries. For example, Wizcom Technologies, Ltd. (Jerusalem, Israel), offers a family of translators and dictionaries called “Quicktionary.” The Quicktionary products are pen-shaped handheld devices that use OCR methods to scan and analyze printed text. Additional details regarding the Quicktionary products can be found at www.wizcomtech.com. Another example of the use of OCR techniques is described by Elgan in “Nothing Lost in Translation,” HP World Magazine, (5:6), June 2002. This article is also available at www.interex.org/hpworldnews/hpw206/pub_hpw_features1.jsp. According to this method, the user takes a picture of the required word using a digital camera. An OCR module produces a string comprising the letters of the word, which is then used for querying the dictionary.

Generally speaking, data entry methods are prone to errors. Therefore, some applications use methods for detecting errors or reducing the possibility of erroneous data entry. One way of reducing the probability of error is using two or more different data entry methods for the same word. This approach is sometimes referred to as “multimodal” data entry. For example, some speech recognition applications use alphanumeric data entry from a telephone keypad. Such a technique is described by Parthasarathy in “Experiments in Keypad-Aided Spelling Recognition,” The 2004 IEEE International Conference on Acoustics, Speech, and Signal Processing (ICASSP 2004), Quebec, Canada, May, 2004. The author describes several schemes for augmenting speech input with input from a telephone keypad in a call-center application.

Another example is a flight reservation system that uses keypad entry for error detection, described by Filisko and Seneff in “Error Detection and Recovery in Spoken Dialogue Systems,” Proceedings of the Human Language Technology Conference, North American Chapter of the Association for Computational Linguistics Annual Meeting (HLT-NAACL 2004), Workshop on Spoken Language Understanding for Conversational Systems, Boston, Mass., May, 2004, pages 31-38.

Some applications use letter spelling or phonetic spelling as a mode for data entry. The paper by Filisko and Seneff cited above also describes a “speak and spell” method, in which the user is asked to spell words as an error recovery measure. Another application, in which a user enters a target word using phonetic spelling, is described in U.S. Pat. No. 6,321,196. Spelling a word phonetically means representing each letter in the word to be spelled by a commonly understood word. For example, one may phonetically spell the work “key” by saying “kilo echo yankee.” The inventor describes a speech recognition system in which the user says a sequence of words selected from a given vocabulary without being restricted to a pre-specified phonetic alphabet. The system recognizes the spoken words, associates letters with these words and then arranges the letters to form the target word.

Another spelling-based application is described in U.S. Pat. No. 5,995,928. The inventors describe a speech recognition system capable of recognizing a word based on a continuous spelling of the word by a user. The system continuously outputs an updated string of hypothesized letters, based on the letters uttered by the user. The system compares each string of hypothesized letters to a vocabulary list of words and returns a best match for the string.

In some speech recognition applications, the user is presented with several alternative results following the automatic recognition process. For example, U.S. Pat. No. 5,027,406 describes a method for creating word models in a natural language dictation system. After the user dictates a word, the system displays a list of the words in the active vocabulary which best match the spoken word. By keyboard or voice command, the user may choose the correct word from the list or may choose to edit a similar word if the correct word is not on the list. Alternatively, the user may type or speak the initial letters of the word.

Another user-assisted method is described in U.S. Patent Application Publication 2002/0064257 A1. The inventors describe a voice-activated dialing system that uses a DTMF (dual-tone multi-frequency) entry device to narrow the possibilities for the selection of a phonetically based name. The user enters a DTMF signature of a name and the signature is used by a dictionary to generate likely possibilities for the word. The user is asked to confirm whether the suggested name is the name entered.

### SUMMARY OF THE INVENTION

There is therefore provided, in accordance with an embodiment of the present invention, a method for querying an electronic dictionary using letters of an alphabet enunciated by a user. The method includes accepting a speech input from the user, the speech input including a sequence of spelled letters enunciated by the user that spell a query word. The speech input is analyzed to determine one or more sequences of the letters that approximate the sequence of spelled letters. The one or more sequences of the letters are post-processed so as to produce a plurality of recognized words approximating the query word. The electronic dictionary is queried with the plurality of recognized words so as to retrieve a respective plurality of dictionary entries. A list of results including the plurality of recognized words and the respective plurality of dictionary entries is presented to the user.

In an embodiment, analyzing the speech input includes applying at least one of an acoustic model and a language model to the speech input. Additionally or alternatively, applying the language model includes representing at least part of the dictionary in terms of a finite state grammar (FSG). Further additionally or alternatively, applying the language model includes assigning probabilities to the sequences of the letters based on a probabilistic language model.

In another embodiment, post-processing the sequences includes defining two or more letter classes including subsets of the letters in the alphabet that have similar sounds, and constructing sequences of the letters by substituting at least one of the letters belonging to the same letter class as at least one of the letters of the query word, so as to produce the plurality of recognized words.

In yet another embodiment, querying the dictionary includes accepting a user command including at least one of a typed input and a voice command, and modifying at least one letter of one of the recognized words based on the user command.

In still another embodiment, presenting the list of results includes assigning likelihood scores to the recognized words on the list and sorting the list based on the likelihood scores. Additionally or alternatively, presenting the list of results includes converting at least part of the list to a speech output, and playing the speech output to the user. Further additionally or alternatively, presenting the list of results includes accepting a user command including at least one of a typed input and a voice command, and scrolling through the list responsively to the user command.

In an embodiment, accepting the speech input includes receiving the speech input via an audio interface associated with a mobile device including at least one of a mobile telephone, a portable computer and a personal digital assistant (PDA), and presenting the list includes providing the list via an output of the mobile device.

In another embodiment, accepting the speech input includes sending the speech input from the mobile device to a remote server that serves one or more users, and presenting the list of results includes transmitting the list of results from the remote server to the mobile device for presentation to the user.

Apparatus and a computer software product for querying an electronic dictionary are also provided.

There is additionally provided, in accordance with an embodiment of the present invention, a system for querying an electronic dictionary using letters of an alphabet enunciated by a user. The system includes a remote server including a memory, which is coupled to store the electronic dictionary.

The system includes one or more spelling processors, which are coupled to accept a speech input from the user, the speech input including a sequence of spelled letters enunciated by the user that spell a query word, to analyze the speech input so as to determine one or more sequences of the letters approximating the sequence of spelled letters, to post-process the one or more sequences of the letters so as to produce a plurality of recognized words approximating the query word, to query the electronic dictionary stored in the memory with the plurality of recognized words so as to retrieve a respective plurality of dictionary entries, and to generate a list of results including the plurality of recognized words and the respective plurality of dictionary entries.

The system also includes a user device, including a client processor, which is coupled to receive the speech input from the user and to send the speech input to the remote server, and which is coupled to receive, responsively to the speech input, the list of results. The user device includes an output device, which is coupled to present the list of results generated by the spelling processor to the user.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for querying an electronic dictionary, in accordance with an embodiment of the present invention;

FIG. 2A is a block diagram that schematically illustrates a mobile device, in accordance with an embodiment of the present invention;

FIG. 2B is a block diagram that schematically illustrates a spelling processor, in accordance with an embodiment of the present invention;

FIG. 3 is a block diagram that schematically illustrates a system for querying an electronic dictionary, in accordance with another embodiment of the present invention;

FIG. 4 is a block diagram that schematically illustrates a system for querying an electronic dictionary, in accordance with yet another embodiment of the present invention; and

FIG. 5 is a flow chart that schematically illustrates a method for querying an electronic dictionary, in accordance with an embodiment of the present invention.

### DETAILED DESCRIPTION OF EMBODIMENTS

### Overview

Embodiments of the present invention provide improved methods and systems that allow users of mobile devices to query an electronic dictionary using spelling recognition. Instead of pronouncing the query word as a whole, as implemented in conventional speech recognition systems, the user vocally spells the query word letter by letter. A spelling processor in the mobile device captures and processes the spelled word. A list of possible recognized words is produced, according to predefined models. A list of results, comprising the recognized words along with the corresponding dictionary entries, is presented to the user. The user can then scroll through the results and identify the correct word and dictionary entry.

In comparison with conventional speech recognition methods that recognize the entire word, spelling recognition typically achieves better recognition performance. Embodiments of the present invention provide a method and a system that are particularly suitable for users who are not familiar with the language in question, such as tourists or foreigners. Such users may not know the correct pronunciation of words but can easily spell them out. Users with speech impairments, whose pronunciation of words may be difficult to understand, may also benefit from the disclosed methods.

On the other hand, reliable letter-by-letter spelling recognition is a non-trivial task that introduces other types of error mechanisms, as will be explained below. The disclosed methods address these error mechanisms by defining appropriate models that determine the list of alternative recognized words. The list is typically sorted by relevance, using relevance measures that are based on the same error mechanisms and/or the model being used.

Some embodiments of the present invention also provide a quick and simple user interface for users of mobile devices. The user interface combines spelling recognition with keypad functions and/or voice commands. This multimodal functionality enables quick and smooth operation of the dictionary application by both ordinary users and users with special needs.

Additionally, the disclosed user interface enables the user to query the dictionary without having to move his or her eyes from the written text. For blind users who read text written in Braille, the user interface enables querying the dictionary without moving the user's fingers away from the page.

In a disclosed embodiment, the result list is converted to speech and played to the user using a text-to-speech (TTS) generator. This implementation is also particularly suitable for blind users and for users who operate the system while driving or carrying out other tasks that require continuous visual attention.

In another embodiment, the dictionary query system is implemented in a remote server configuration using distributed speech recognition (DSR).

### System Description

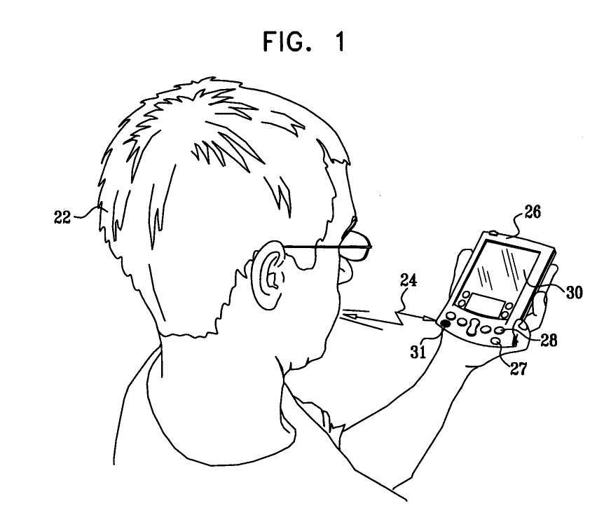

FIG. 1 is a schematic, pictorial illustration of a system for querying an electronic dictionary, in accordance with an embodiment of the present invention. A user 22 communicates using speech 24 with a mobile device 26, for querying an electronic dictionary. The mobile device may comprise a personal digital assistant (PDA), such as one of the palmOne™ PDA products (see www.palmone.com). The mobile device may alternatively comprise a laptop computer, a mobile phone or another device with suitable computational and I/O capabilities. Although the embodiments described hereinbelow relate to mobile devices by way of illustration, the principles of the present invention may also be applied in non-mobile computing devices, such as desktop computers.

The mobile device typically comprises a microphone 27 for accepting speech from the user and a keypad 28 for accepting user input. A display 30 presents textual information to the user. In some embodiments, mobile device 26 also comprises a speaker 31 for playing synthesized speech to the user, as will be explained below.

The electronic dictionary application may comprise a thesaurus or a lexicon, in which case querying the dictionary means retrieving a definition of a word. Alternatively, the dictionary may comprise a bilingual or multilingual dictionary, in which case querying the dictionary means retrieving a translation of the word to another language. Additional dictionary applications comprise dictionaries that are specific to particular professional disciplines and phrasebooks that translate phrases from one language to another. Other dictionary applications will be apparent to those skilled in the art, and can be implemented using the methods described hereinbelow. In the context of the present patent application and in the claims, the term “dictionary” pertains to any such dictionary application. The term “dictionary entry” refers to the definition or the translation of a word or phrase, as relevant to the particular application.

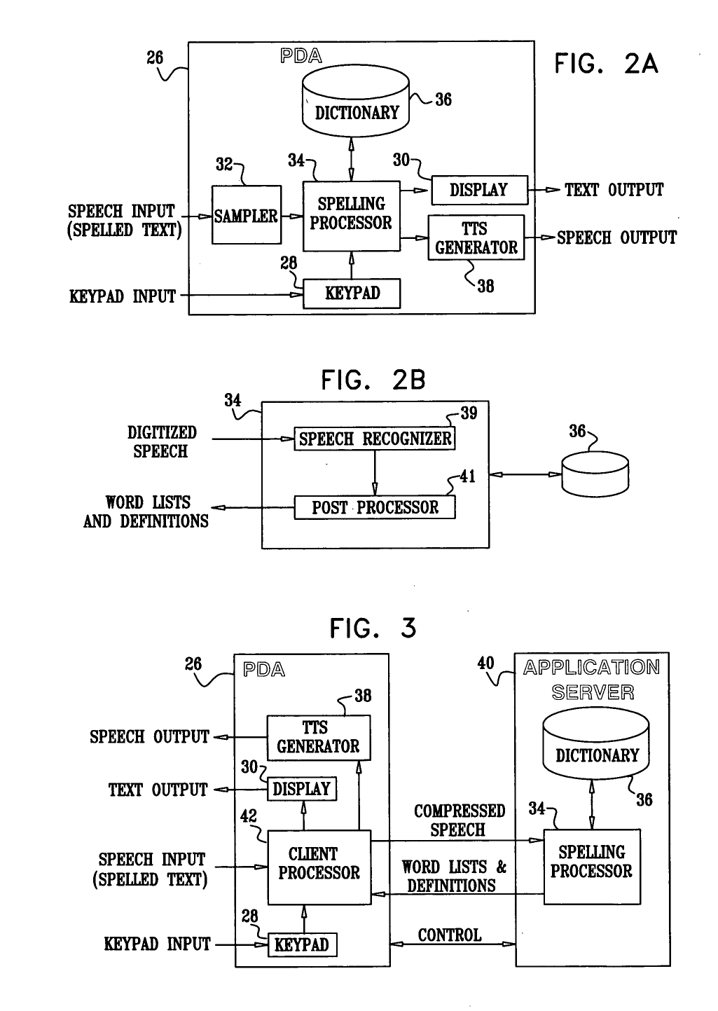

FIG. 2A is a block diagram that schematically illustrates mobile device 26, in accordance with an embodiment of the present invention. Mobile device 26 comprises an input device, such as a microphone 27, that accepts speech input from the user. The speech comprises a query word or phrase, spelled letter-by-letter by the user. A sampler 32 samples the speech input and produces digitized speech. A spelling processor 34 processes the digitized speech and produces a list of possible recognized words. Several alternative recognition methods are explained in detail in the description of FIG. 5 below.

The spelling processor is typically implemented as a software process that runs on a central processing unit (CPU) of the mobile device. The spelling processor queries an electronic dictionary 36, which is stored in a memory of the mobile device, and retrieves dictionary entries corresponding to the recognized words. The spelling processor typically displays the list of results using an output device such as display 30. Additionally or alternatively, the output device comprises a text to speech (TTS) generator 38 that converts the list of results, or parts of it, to speech and plays it to the user. Again, a detailed description of the method and the associated user interfaces is given in the description of FIG. 5 below.

FIG. 2B is a block diagram that schematically shows details of spelling processor 34, in accordance with an embodiment of the present invention. In some embodiments, the spelling recognition process carried out by processor 34 can be divided into two consecutive steps. A speech recognizer 39 in processor 34 accepts the digitized speech. The speech recognizer applies a suitable model to the digitized speech so as to produce one or more letter sequences that represents a possibly-recognized word. Each letter sequence is assigned a probability value indicating the probability of the particular letter sequence representing the word spelled by the user. In some embodiments, speech recognizer 39 queries dictionary 36 as part of the recognition process. In alternative embodiments, the model used by recognizer 39 already contains at least part of the dictionary.

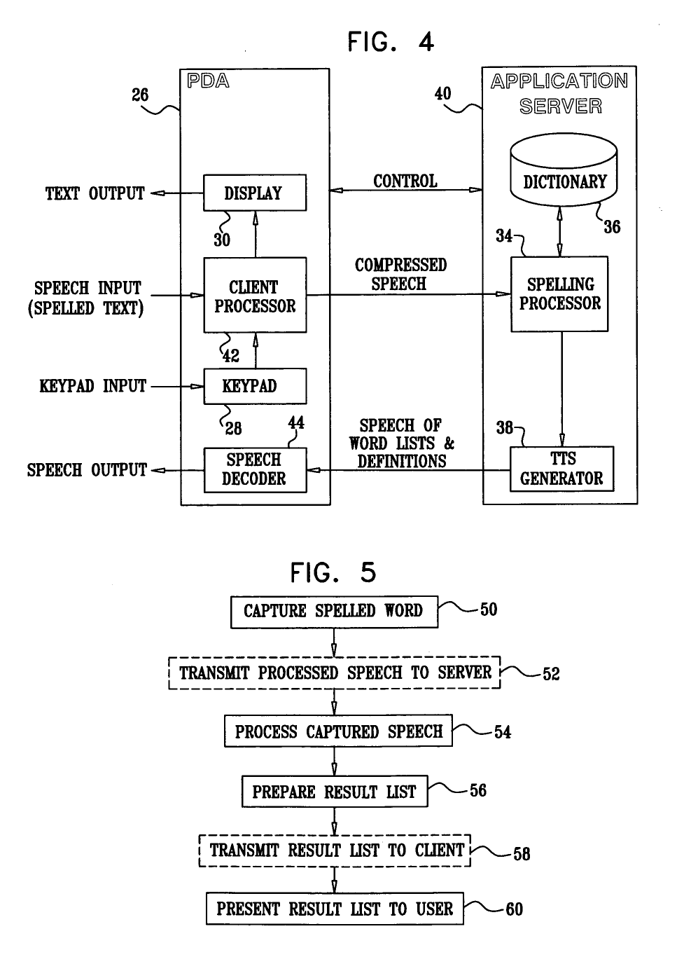

A post processor 41 in spelling processor 36 accepts the letter sequences and associated probabilities from recognizer 39. The post processor queries dictionary 36 with the recognized words and produces an ordered list of results. The list comprises the recognized words and the associated dictionary definitions of these words. The configuration of spelling processor 34 shown in FIG. 2B is typically used in both the local configuration shown in FIG. 2A above and in the remote server configuration shown in FIGS. 3 and 4 below. In some embodiments, speech recognizer 39 and post processor 41 are implemented as two software processes managed by spelling processor 34.

FIG. 3 is a block diagram that schematically illustrates a remote server system for querying electronic dictionary 36, in accordance with another embodiment of the present invention. In some cases it is preferable to implement the dictionary application using a remote server configuration. In a remote server configuration, the electronic dictionary is located in a single central location. Multiple users can query the dictionary using distributed speech recognition (DSR) techniques, as are known in the art.

A centralized dictionary configuration is sometimes preferred because it enables the use of larger dictionaries. Large dictionaries, or dictionaries holding large and detailed entries, may significantly exceed the memory storage capabilities of typical mobile devices. Additionally, maintaining and updating information in a centralized dictionary data structure is often easier than managing multiple dictionaries distributed between multiple users.

The configuration shown in FIG. 3 comprises an application server 40. Spelling processor 34 and dictionary 36 are located in server 40. Although FIG. 3 shows a single spelling processor, typical implementations of server 40 comprise multiple spelling processors 34 that interact with multiple mobile devices 26. The multiple spelling processors are typically implemented as parallel software instances or threads running on one or more CPUs of server 40. Dictionary 36 can be implemented using any suitable data structure, such as a database, suitable for multi-user access.

In the remote server configuration, mobile device 26 comprises a client processor 42 that accepts the speech input from the user via microphone 27 and sampler 32 (not shown in this figure). Processor 42 compresses the captured and digitized speech and transmits it, typically in a compact form, such as a stream of compressed feature vectors, to spelling processor 34 in server 40. The spelling processor decompresses the feature vectors, processes the decompressed speech and queries dictionary 36, according to the method of FIG. 5 below. The processing performed by spelling processor 36 in the remote server configuration is similar to that performed in the local configuration shown in FIG. 2A above. The spelling processor sends the list of recognized words and the corresponding dictionary entries to client processor 42 in the mobile device. The client processor presents the results to the user using display 30 and/or TTS generator 38. The client processor handles the user interface, which allows the user to scroll and edit the list of results using keypad 28 and/or voice commands. Again, the user interface is explained in detail in the description of FIG. 5 below.

Mobile device 26 and server 40 are linked by a communication channel. The channel is used to send compressed speech to the server, send result lists to the mobile device and exchange miscellaneous control information. The communication channel may comprise any suitable medium, such as an Internet connection, a telephone line, a wireless data network, a cellular network, or a combination of several such media.

FIG. 4 is a block diagram that schematically illustrates a remote server system for querying electronic dictionary 36, in accordance with yet another embodiment of the present invention. The configuration of FIG. 4 is similar to the configuration of FIG. 3 above, except that in the configuration of FIG. 4 the text-to-speech conversion function is also split between the server and the mobile device. Server 40 here comprises TTS generator 38, which in this embodiment accepts the list of results from the spelling processor and converts it (or parts of it) to a stream of compressed speech feature vectors. The compressed speech is then sent to the mobile device over the communication channel. A speech decoder in the mobile device decompresses and decodes the received feature vectors and plays the decoded speech to the user.

Typically, spelling processor 34 and client processor 42 comprise general-purpose computer processors, which are programmed in software to carry out the functions described herein. The software may be downloaded to the computers in electronic form, over a network, for example, or it may alternatively be supplied to the computers on tangible media, such as CD-ROM. Further alternatively, the spelling processor may be a standalone unit, or it may alternatively be integrated with other computing functions of mobile device 26 or server 40. Additionally or alternatively, at least some of the functions of the spelling processor may be implemented using dedicated hardware. Client processor 42 may also be integrated with other computing functions of mobile device 26.

### Dictionary Querying Method Description

FIG. 5 is a flow chart that schematically illustrates a method for querying electronic dictionary 36, in accordance with an embodiment of the present invention. The method begins with user 22 entering a query word or phrase, at a word entry step 50. For this purpose, the user first initiates the dictionary application running on mobile device 26. The user then starts the speech acquisition process, for example by clicking a button on keypad 28. The user spells the query word vocally, letter by letter. After spelling the entire word the user stops the speech acquisition process, for example using keypad 28. The mobile device captures the speech comprising the sequence of spelled letters using microphone 27. Sampler 32 digitizes the captured speech. In another embodiment, the user can start and stop the speech acquisition process using predetermined voice commands.

(If the disclosed method is implemented using a remote server configuration, as shown in FIGS. 3 and 4 above, client processor 42 transmits data, typically in the form of a stream of compressed feature vectors, that represent the processed speech to the spelling processor, at a speech transmission step 52. As shown in FIGS. 3 and 4 above, the spelling processor in such a configuration is part of server 40. If the method is implemented locally in the mobile device, as shown in FIG. 2A above, step 52 is omitted.)

Speech recognizer 39 and post processor 41 in spelling processor 34 (FIG. 2B) process the digitized speech, at a speech processing step 54. Speech recognizer 39 analyzes the digitized speech, typically segmenting the speech into phonetic components that represent individual letters of the query word. Various methods are known in the art for identifying a phonetic sound within a limited vocabulary. Any suitable method can be used by the speech recognizer to identify the spelled letters in the captured speech. Most methods do not require user-specific training (sometimes referred to as “user enrollment”) because of the small vocabulary and the small user-dependent differences in pronunciation of spelled letters.

However, in specific cases, such as users with speech impairments or users with heavy accents, the use of learned user-specific speech characteristics may improve the quality of recognition. In some embodiments, speech recognizer 39 extracts additional information from the digitized speech, to be used in the recognition process as will be explained below.

In some embodiments, the speech recognizer uses a suitable acoustic model for assigning a likelihood score to each identified spelled letter. Each likelihood score quantifies the likelihood that the particular letter was indeed iterated by the user.

The speech recognizer uses a language model, which may be based in whole or in part on the dictionary being used. Using the language model, the speech recognizer generates one or more letter sequences that represent possibly-recognized words in response to the captured input speech.

In some embodiments, the language model comprises a graph representing the dictionary, which is commonly referred to as a Finite State Grammar (FSG). Finite state grammars (sometimes also referred to as finite-state networks) are described, for example, by Rabiner and Juang in “Fundamentals of Speech Recognition,” Prentice Hall, April 1993, pages 414-416. The nodes of the FSG represent letters of the alphabet. (In typical implementations, each letter of the alphabet appears several times in the graph.) Arcs between nodes represent adjacent letters in legitimate words. In other words, each word in the dictionary is represented as a trajectory or path through the graph.

In some embodiments, only part of the dictionary is represented as a FSG. In many practical cases, FSG-based models are used for small to medium size vocabularies and dictionaries, typically up to several thousands of words.

When using the FSG, the speech recognizer typically compares the sequence of spelled letters of the digitized speech to the different trajectories through the FSG. In some embodiments, the speech recognizer assigns likelihood scores to the trajectories. The speech recognizer produces the letter sequences and the associated likelihood scores.

In other embodiments, the language model comprises a probabilistic language model, which assigns probabilities to different letter sequences in the vocabulary. Probabilistic language models are described, for example, by Young in “A Review of Large-Vocabulary Continuous-Speech Recognition,” IEEE Signal Processing Magazine, September 1996, pages 45-57. Probabilistic language models are typically used when the size of the dictionary is very large, making it difficult to represent every word in the model explicitly. In these embodiments, speech recognizer 39 produces one or more letter sequences that resemble the sequence of spelled letters, with associated likelihood scores in accordance with the probabilistic language model.

In yet another embodiment, the speech recognizer represents the different letter sequences produced by the probabilistic language model in terms of a lattice. The lattice is a graph comprising the possible sequences of letters, with each sequence assigned a respective likelihood score, according to the probabilistic language model.

Following the speech recognition process, speech recognizer 39 provides to post processor 41 one or more letter sequences with associated likelihood scores, as described above.

In one embodiment, when speech recognizer 39 uses a FSG as the language model, the letter sequences provided to post processor 41 are already legitimate words that appear in dictionary 36.

In another embodiment, in which speech recognizer 39 uses a probabilistic language model with lattice output, as described above, post processor 41 selects a subset of the letter sequences in the lattice, having the highest likelihood scores. Since not all of the possible letter sequences in the lattice necessarily correspond to legitimate dictionary words, post processor 41 typically queries dictionary 36 with the selected letter sequences, and discards words that do not appear in the dictionary.

In yet another embodiment, in which speech recognizer 39 uses a probabilistic language model, speech recognizer 39 outputs only the letter sequence having the maximum likelihood score (referred to hereinbelow as the highest ranking sequence). Post processor 41 constructs a list of alternative letter sequences based on the highest ranking sequence by using letter classes, as explained below.

Spelled letters can be classified into letter classes based on their pronunciation characteristics. During speech recognition, some spelled letters may be mistaken for one another. For example, the spelled letters /b/, /c/, /d/, /e/, /g/, /p/, /t/, /v/ and /z/ all belong to the same letter class (referred to as the “e-class”) . These letters all have similar vowel sounds when spelled. In some cases, the speech recognizer may erroneously mistake one such letter for another. Similarly, the speech recognizer may erroneously interchange letters belonging to the “a-class” (/a/, /h/, /j/, /k/), the “i-class” (/i/, /y/) and the “u-class” (/u/, /q/).

The probabilities of mistaking one letter for another are typically represented as a matrix, which is called a “confusion matrix.” The probability of interchanging letters belonging to different letter classes is assumed to be small. When using letter classes, the post processor constructs the list of alternative letter sequences by replacing each letter of the best ranking sequence with similarly-sounding letters, according to the letter classes described above. The post processor typically ranks the list, for example by computing likelihood scores based on the confusion matrix.

For example, assume that the best ranking sequence, as recognized by speech recognizer 39, is /c/, /a/ and /t/, assuming the user has spelled the word “cat.” Using the letter classes described above, the post processor constructs a list of alternative letter sequences defined by [{e-class}, {a-class}, {e-class}] (i.e., all 9×4×9=324 three-letter strings, in which the first letter belongs to the e-class, the second letter belongs to the a-class and the third letter again belongs to the e-class). In some embodiments, the alternative letter sequences may also comprise a different number of letters, or letters from other letter classes. For example, the query word “cat” can also be recognized as “beat.”

Obviously, only a few of the alternative letter sequences produced in the above example (such as “bat”, “the”, “pad” and the original “cat”) are meaningful words. Most are meaningless strings. Note also that the pronunciation of the entire words may be very different from the pronunciation of the query word. As an extreme example, the sound of the word “the” is very different from the sound of the word “cat”. Nevertheless, these two words are both considered legitimate alternative letter sequences by the spelling processor, because the spelled sequence /t/, /h/, /e/ does sound similar to the spelled sequence /c/, /a/, /t/. The post processor maintains (or produces in the first place) only the letter sequences that correspond to meaningful words. The post processor may differentiate between meaningful and meaningless letter sequences by querying dictionary 36 or by using any suitable grammatical rules, which are part of the language model being used.

In order to minimize the probability of false recognition, the spelling processor may request the user's assistance in determining which one of the recognized letter sequences, or recognized words, is the original query word entered by the user. For this purpose, the post processor prepares a list of results, at a list preparation step 56. In some embodiments, the post processor produces the list of results in accordance with one of the language models described above. In some embodiments, the post processor sorts the list of results in descending order of relevance. The relevance score of a particular recognized word is typically determined in accordance with the language model being used, as described above. Alternatively, the list can be sorted alphabetically, or using any other suitable criterion.

(If the disclosed method is implemented using a remote server configuration, as shown in FIGS. 3 and 4 above, spelling processor 34 in server 40 transmits the list of results to client processor 42, at a result transmission step 58. If the method is implemented locally in the mobile device, as shown in FIG. 2A above, step 58 is omitted.)

The spelling processor presents the list of results to the user, at a presentation step 60. Typically, the list of recognized words is displayed as text on display 30 of the mobile device. The user may scroll through the list using keypad 28 until he or she finds the intended query word and the corresponding dictionary entry. Alternatively, only the first word on the list is displayed together with its dictionary entry. If the first recognized word on the result list is incorrect, the user may scroll down and select the next word. Any other suitable presentation method can be used, depending upon the particular application and the capabilities of keypad 28 and display 30 of the mobile device. Additionally, the user can also edit the displayed recognized words at any time using the keypad, so as to enter part or all of the intended query word.

In another embodiment, the list of results is converted to speech using TTS generator 38 and played to the user through speaker 31. The user can indicate, either using the keypad or by uttering a voice command, when the correct word is being played. After selecting the correct word, the TTS generator plays the corresponding dictionary entry.

Although the disclosed methods mainly address spelling-based dictionary lookup in mobile devices, the same methods can be used in a variety of additional applications. For example, the disclosed methods can also be used in desktop or mainframe computer applications that require high quality word recognition. Such applications include, for example, directory assistance services and name dialing applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for querying an electronic dictionary using letters of an alphabet enunciated by a user, the method comprising:
accepting a speech input from the user, the speech input comprising a sequence of spelled letters enunciated by the user that spell a query word;
analyzing the speech input to determine one or more sequences of the letters that approximate the sequence of spelled letters;
post-processing the one or more sequences of the letters so as to produce a plurality of recognized words approximating the query word;
querying the electronic dictionary with the plurality of recognized words so as to retrieve a respective plurality of dictionary entries; and
presenting a list of results comprising the plurality of recognized words and the respective plurality of dictionary entries to the user.

2. The method according to claim 1, wherein analyzing the speech input comprises applying at least one of an acoustic model and a language model to the speech input.

3. The method according to claim 2, wherein applying the language model comprises representing at least part of the dictionary in terms of a finite state grammar (FSG).

4. The method according to claim 2, wherein applying the language model comprises assigning probabilities to the sequences of the letters based on a probabilistic language model.

5. The method according to claim 1, wherein post-processing the sequences comprises defining two or more letter classes comprising subsets of the letters in the alphabet that have similar sounds, and constructing sequences of the letters by substituting at least one of the letters belonging to the same letter class as at least one of the letters of the query word, so as to produce the plurality of recognized words.

6. The method according to claim 1, wherein querying the dictionary comprises accepting a user command comprising at least one of a typed input and a voice command, and modifying at least one letter of one of the recognized words based on the user command.

7. The method according to claim 1, wherein presenting the list of results comprises assigning likelihood scores to the recognized words on the list and sorting the list based on the likelihood scores.

8. The method according to claim 1, wherein presenting the list of results comprises converting at least part of the list to a speech output, and playing the speech output to the user.

9. The method according to claim 1, wherein presenting the list of results comprises accepting a user command comprising at least one of a typed input and a voice command, and scrolling through the list responsively to the user command.

10. The method according to claim 1, wherein accepting the speech input comprises receiving the speech input via an audio interface associated with a mobile device comprising at least one of a mobile telephone, a portable computer and a personal digital assistant (PDA), and wherein presenting the list comprises providing the list via an output of the mobile device.

11. The method according to claim 10, wherein accepting the speech input comprises sending the speech input from the mobile device to a remote server that serves one or more users, and wherein presenting the list of results comprises transmitting the list of results from the remote server to the mobile device for presentation to the user.

12. Apparatus for querying an electronic dictionary using letters of an alphabet enunciated by a user, the apparatus comprising:
a memory, which is arranged to store the electronic dictionary;
a spelling processor, which is arranged to accept a speech input from the user, the speech input comprising a sequence of spelled letters enunciated by the user that spell a query word, to analyze the speech input so as to determine one or more sequences of the letters that approximate the sequence of spelled letters, to post-process the one or more sequences of the letters so as to produce a plurality of recognized words approximating the query word, to query the electronic dictionary stored in the memory with the plurality of recognized words so as to retrieve a respective plurality of dictionary entries, and to generate a list of results comprising the plurality of recognized words and the respective plurality of dictionary entries; and
an output device, which is coupled to present the list of results generated by the spelling processor to the user.

13. The apparatus according to claim 12, wherein the spelling processor comprises a speech recognizer, which is arranged to apply at least one of an acoustic model and a language model so as to analyze the speech input.

14. The apparatus according to claim 13, wherein the language model comprises a finite state grammar (FSG) representing at least part of the dictionary.

15. The apparatus according to claim 13, wherein the language model comprises a probabilistic language model, and wherein the speech recognizer is arranged to assign probabilities to the recognized words based on the probabilistic language model.

16. The apparatus according to claim 12, wherein the spelling processor is arranged to define two or more letter classes comprising subsets of the letters in the alphabet that have similar sounds, and to construct sequences of the letters by substituting at least one of the letters belonging to the same letter class as at least one of the letters of the query word, so as to produce the plurality of recognized words.

17. The apparatus according to claim 12, wherein the spelling processor is arranged to accept a user command comprising at least one of a typed input and a voice command, and to modify at least one letter of one of the recognized words based on the user command.

18. The apparatus according to claim 12, wherein the spelling processor is arranged to assign likelihood scores to the recognized words on the list of results and to sort the list based on the likelihood scores.

19. The apparatus according to claim 12, wherein the output device comprises a text-to-speech converter, which is arranged to convert at least part of the list to a speech output and to play the speech output to the user.

20. The apparatus according to claim 12, wherein the spelling processor is arranged to receive the speech input via an audio interface associated with a mobile device comprising at least one of a mobile telephone, a portable computer and a personal digital assistant (PDA), and to provide the list of results via an output of the mobile device.

21. A system for querying an electronic dictionary using letters of an alphabet enunciated by a user, the system comprising:
a remote server comprising:
a memory, which is coupled to store the electronic dictionary; and
one or more spelling processors, which are coupled to accept a speech input from the user, the speech input comprising a sequence of spelled letters enunciated by the user that spell a query word, to analyze the speech input so as to determine one or more sequences of the letters approximating the sequence of spelled letters, to post-process the one or more sequences of the letters so as to produce a plurality of recognized words approximating the query word, to query the electronic dictionary stored in the memory with the plurality of recognized words so as to retrieve a respective plurality of dictionary entries, and to generate a list of results comprising the plurality of recognized words and the respective plurality of dictionary entries; and
a user device, comprising:
a client processor, which is coupled to receive the speech input from the user and to send the speech input to the remote server, and which is coupled to receive, responsively to the speech input, the list of results; and
an output device, which is coupled to present the list of results generated by the spelling processor to the user.

22. A computer software product for querying an electronic dictionary using letters of an alphabet enunciated by a user, the product comprising a computer-readable medium in which program instructions are stored, which instructions, when read by a computer, cause the computer to accept a speech input from the user, the speech input comprising a sequence of spelled letters enunciated by the user that spell a query word, to analyze the speech input so as to determine one or more sequences of the letters approximating the sequence of spelled letters, to post-process the one or more sequences of the letters so as to produce a plurality of recognized words approximating the query word, to query the electronic dictionary with the plurality of recognized words so as to retrieve a respective plurality of dictionary entries, to generate a list of results comprising the plurality of recognized words and the respective plurality of dictionary entries, and to output the list of results generated by the spelling processor for presentation to the user.
